(19) United States
(12) Patent Application Publication
(10) Pub. No.: US 2019/0374430 A1
(43) Pub. Date: Dec. 12, 2019

(54) Autonomous Mechanical CPR Device

(71) Applicant: Defibtech, LLC, Guilford, CT (US)

(72) Inventors: Patrick Perdu, San Jose (CR); Robert W. Gorry, Jr., New Haven, CT (US); Matthew Valentine, Madison, CT (US)

(21) Appl. No.: 16/003,767

(22) Filed: Jun. 8, 2018

(51) Int. Cl. A61H 31/00

(52) U.S. Cl. CPC A61H 31/006; A61H 31/008; A61H 2201/5058; A61H 2201/168; A61H 2201/1215; A61H 2201/5007

(57) ABSTRACT

An autonomous mechanical CPR device and method is disclosed for adjusting the therapeutic position of a CPR surface during a CPR session. The adjustment of the CPR surface permits the CPR surface to maintain better proximity to a victim's chest.

### TECHNICAL FIELD

The invention relates to kinesitherapy and more specifically to provide cardio pulmonary resuscitation (CPR).

### BACKGROUND OF THE INVENTION

Cardio Pulmonary Resuscitation (CPR) is a well-known, first-aid treatment ideally performed on a victim suffering cardiac arrest. CPR is an external heart massage technique that manually preserves blood circulation through a victim's body in an attempt to maintain the body's organs, primarily the brain, until a normal heart rhythm, or blood flow, can be restored.

In the treatment, a person's chest (i.e., sternum) is compressed. The compressions of the chest in turn cause compression of the heart forcing blood to circulate through the cardiovascular system.

Performing manual CPR (i.e., CPR compressions given by a person) is strenuous, even using devices that provide a mechanical advantage. Proper CPR requires about 100, 5-cm-deep compressions of the chest per minute, each compression potentially requiring a force upwards of 550 N. Therefore, maintaining high-quality, manual CPR for an extended period of time, even more than several minutes, can be exhausting. Additionally, as close proximity of the CPR provider to victim is required for manual CPR, maintaining continuous manual CPR is compromised when the victim on whom the CPR is being performed is being moved, whether being carried on a backboard (e.g., through doorways, down halls or on stairs) or transported in a vehicle.

Autonomous mechanical CPR devices, which are well known in the art, can overcome many of the issues associated with providing CPR for extended periods of time. These CPR devices can be associated with a victim and once started do not require human intervention, or even necessitate human proximity, and will continue CPR as long as their power source permits.

Autonomous mechanical CPR devices generally comprise a support assembly having a CPR unit (i.e., a device capable of compressing a chest) defining a freestanding structure. The support assembly typically mounts to a back plate, which is positioned under a victim, with the support assembly extending over the victim. In other words, the support assembly and back plate define an opening in which the victim is placed.

What is needed in the art are autonomous mechanical CPR devices that are easy to store and deploy, and are compatible with a broad spectrum of body types.

### SUMMARY OF THE INVENTION

The invention is an autonomous mechanical CPR device. The device has a CPR unit attached to a free-standing support assembly. In operation, a victim is placed in the support assembly such that the CPR unit can compress the victim's chest. The CPR device is preferably portable, and it provides the recommended depth of chest compression at the recommended rate.

As an optional feature, the CPR device may include the ability to adjust the support assembly to permit the CPR unit to be placed properly relative to a victim's chest. In addition, the CPR unit may contain programming to allow relevant components of the CPR unit to be positioned autonomously by the CPR unit relative to a victim's chest.

These and other aspects and advantages of the invention will become apparent from the following detailed description and the accompanying drawings which illustrate by way of example the features of the invention.

### BRIEF DESCRIPTION OF THE DRAWINGS

FIG. 1 is a front view drawing of the CPR Device.

FIG. 2 is a top view drawing of the CPR Device.

FIG. 3 is a side view drawing of the CPR Device.

FIG. 4 is a side view drawing of the backplate.

FIG. 5 is a top view drawing of the backplate.

FIG. 6 is a side view drawing of a latch assembly.

FIG. 7 is a side view drawing of the latch handle, which is part of the latch assembly.

FIG. 8 is a front view drawing of the latch assembly.

FIG. 9 is a section drawing taken along line 9-9, shown in FIG. 1.

FIG. 10 is a section drawing taken along line 10-10, shown in FIG. 3, with the outer surface removed and the backplate removed.

FIG. 11 is a section drawing taken along line 10-10, shown in FIG. 3, with the outer surface removed and the backplate partially inserted.

FIG. 12 is a section drawing taken along line 10-10, shown in FIG. 3, with the outer surface removed and the backplate fully inserted.

FIG. 13 is a side view drawing with a section removed of the motor.

FIG. 14 is a section view drawing of the motor depicted in FIG. 13 taken alone line 14-14, with the section removed in FIG. 13 indicated.

FIG. 15 is a side view drawing of the inner sleeve.

FIG. 16 is a top view drawing of the inner sleeve.

FIG. 17 is a side view drawing of the telescoping sleeve.

FIG. 18 is a top view drawing of the telescoping sleeve.

FIG. 19 is a side view drawing of the exterior sleeve.

FIG. 20 is a top view drawing of the exterior sleeve.

FIG. 21 is a drawing similar to FIG. 13 except the inner sleeve is extended.

FIG. 22 is a drawing similar to FIGS. 13 and 21 except the inner sleeve has been sufficiently extended to cause the extension of telescoping sleeve.

FIG. 23 is a side view drawing of the driveshaft with a section removed to show internal details.

FIG. 24 is a side view drawing of the insert.

FIG. 25 is a top view drawing of the insert.

FIG. 26 is a side view drawing of a first mount.

FIG. 27 is the top view drawing of the first mount.

FIG. 28 is drawing of a user interface.

FIG. 29 is a perspective side view drawing of a power system.

FIG. 30 is a perspective view drawing of the power system slot in the compression system with the power system removed.

FIG. 31 is a cut away side view drawing of a first embodiment of a CRP pad ready to be mounted on the ram.

FIG. 32 is a bottom view of the flange shown in FIG. 31 taken along line 32-32.

FIG. 33 is a top view drawing of the CPR pad shown in FIG. 31 taken along line 33-33.

FIG. 34 is a cut away perspective view drawing of the first embodiment of the CPR pad.

FIG. 35 is a perspective view drawing of a second embodiment of a CPR pad.

FIG. 36 is a cut-away perspective view drawing of the CPR pad shown in FIG. 34.

FIG. 37 is a cut away, perspective view drawing of a third embodiment of a CPR pad.

FIG. 38 is a perspective view drawing of the third embodiment of the CPR pad.

FIG. 39 is a diagram of a CPR compression stroke depicting the position of the ram and a victim's chest where the chest fully decompresses.

FIG. 40 is a diagram of three consecutive CPR strokes and a variable contact level.

FIG. 41 is a diagram of three CPR strokes and a fixed contact level.

### DETAILED DESCRIPTION

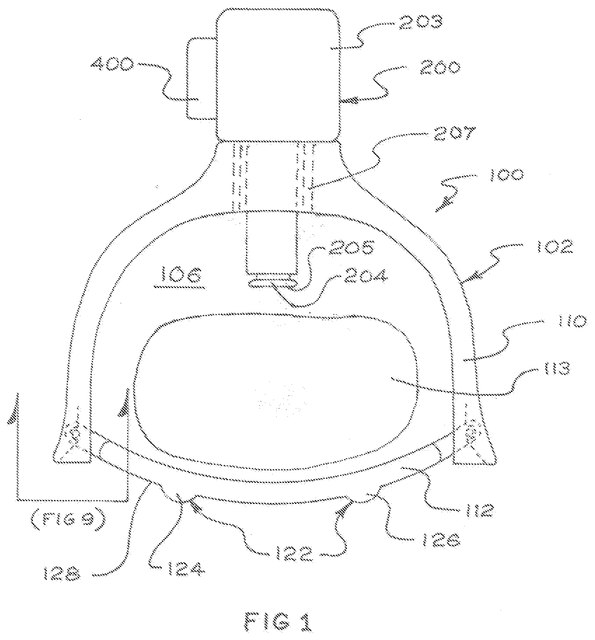

As shown in FIG. 1 the CPR device, generally referred to by reference number 100 includes a support assembly (generally referred to by reference number 102), a compression system (generally referred to by reference number 200), a control system (generally referred to by reference number 350), and a power system (generally referred to by reference number 400).

Support Assembly

The support assembly 102 includes an arch 110 that connects to a backplate 112. The arch 110 and backplate 112 cooperate to define an opening 106 suitable in cross-section to allow placement of a victim within the support assembly 102. More specifically, the cross-section of the support assembly 102, in the region under the lowest point of the compression system 200, is sized based on the transverse cross-section of a human torso 113 in the thoracic region at the position of the heart (i.e., when the back is positioned on the back plate and the sternum is under the compression system). The actual size of the cross-section of the support assembly 102 is a matter of design choice; however, a suitable cross-section would allow the CPR device 100 to be used on a substantial portion of the population.

The support assembly 102 is rigid. As used herein, “rigid” means a structure that is not flexible, but may be subject to minor temporary deflections, which may be perceptible or not, when loads are applied under normal operating conditions.

As shown in FIGS. 1-3, the arch 110, which is illustrated as generally symmetrical, has handles 114, 116, one on each side. The handles 114, 116 allow a user to grasp the arch 110 to accomplish such actions as disconnecting the arch 110 from the backplate 112, or placing the arch over a victim and connecting it to the backplate, which would be positioned under the victim.

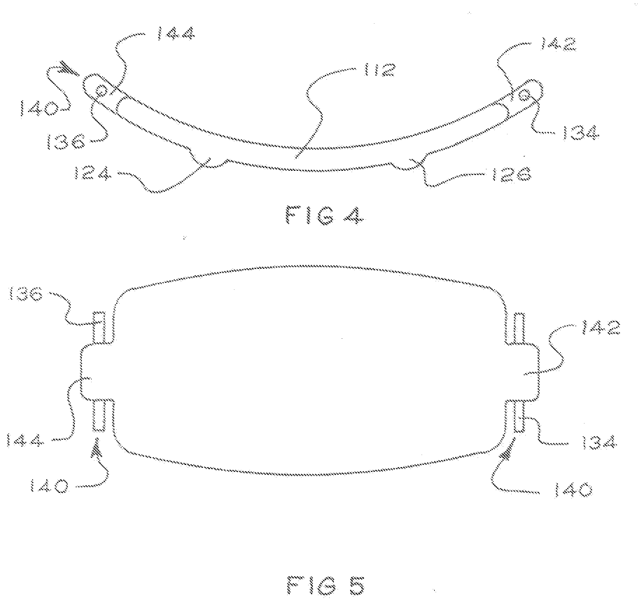

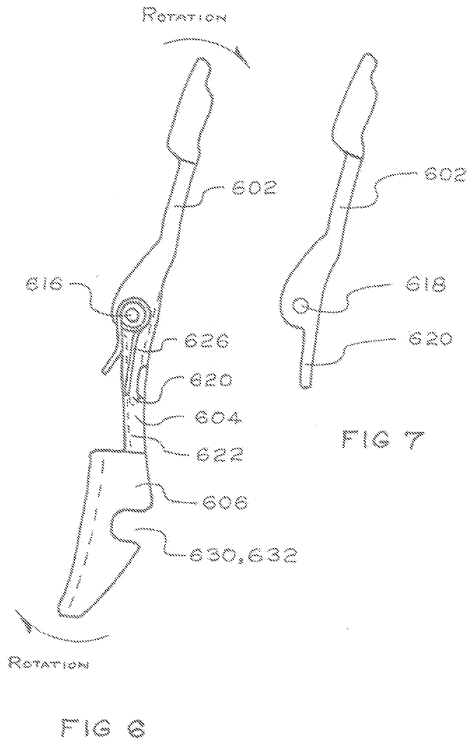

Referring to FIGS. 4 and 5, the backplate 112 preferably has a curvature generally consistent with that of a victim's back. To provide stability to the backplate or to the support assembly 102 when placed on a surface, a passive anti-roll system 122 may be incorporated. The illustrated passive anti-roll system 122 may be a cooperating pair of protrusions 124, 126 extending outwardly from the bottom 128 (the side opposite that in contact with the victim's back) of the backplate 112. Preferably, the protrusions 124, 126 are sized such that when the backplate 112 is placed on a flat surface (not shown) both protrusions are simultaneously in contact with the surface. However, the protrusions 124, 126 maybe sized to work independently in corporation with a portion of the bottom 128.

The backplate 112 further includes tabs 142, 144 that extend outwardly from the ends of backplate. Extending through and outwardly from each tab is a latch pin 134, 136.

The arch 110 is connected to the backplate 112 by a latch system (generally referred to by reference number 140). A first portion of the latch system 140 is located in the arch 110 and a cooperating second portion is located in the backplate 112. In the illustrative example, there are two latch systems 140.

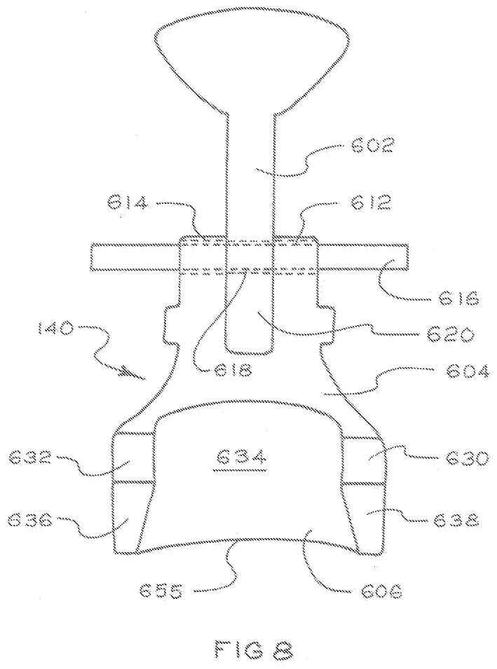

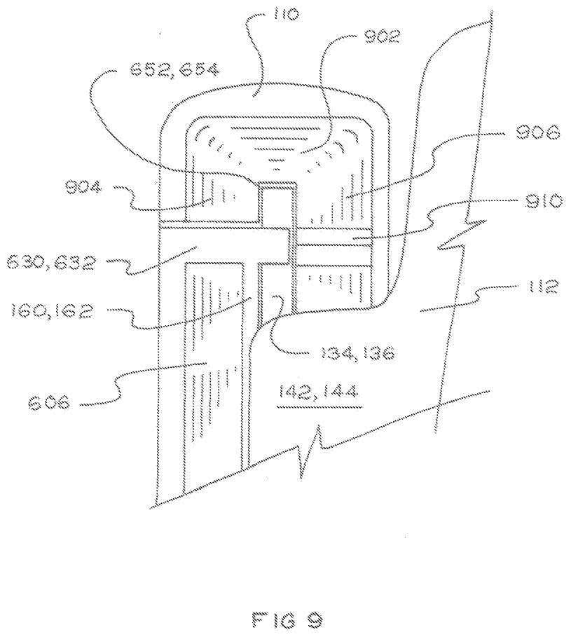

Continuing with FIGS. 6, 7 and 8, the latch 600, which is the first portion of the latch system 140, includes a latch handle 602 and a latch portion 606 connected by a mid-section 604. More specifically, the mid-section 604 defines a pair of cooperating bores 612, 614. The latch handle 602 also defines a bore 618. An axle 616 is passed through the bores 612, 614, 618 thereby rotationally connecting the mid-section 604 to the latch handle 602. The latch portion 606 is rigidly connected to the mid-section 604.

Extending from the latch handle 602 is a tab 620 that abuts a bearing surface 622 in the mid-section 604. When the latch handle 602 is pushed such that the tab 620 interacts with the bearing surface 622, the latch handle pivots about the axle 616 and the tab causes the mid-section 604 to rotate in the same direction, which in turn moves the latch portion 606. It should be appreciated that since both the latch handle 602 and the mid-section 604 pivot about the axle 616, and the two are not rigidly connected, the latch portion 606 can be rotated about the axle independently of the latch handle.

The latch portion 606 includes cooperating detents 630, 632, a cavity 634 dimensioned to receive a tab 142, 144 located on the backplate 112, and bearing surfaces 636, 638.

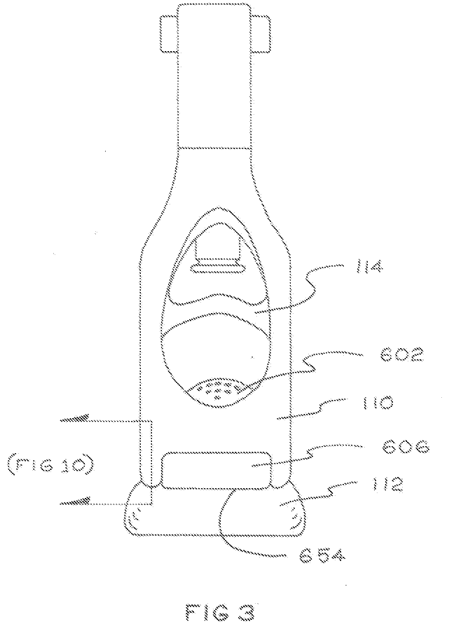

Referring to FIG. 3, the latch handle 602 is positioned on the arch 110, one below each handle 114, 116. The latch handle 602 is positioned relative to its respective handle 114, 116 such that the fingers of a hand can depress the latch handle inward (into the opening 106) to release the arch 110 from the backplate 112. More specifically, a hand is placed on a handle 114, 116 such that the thumb is on the inside (the side within the opening 106) and the fingers are extending downward on the other side. The placement of the latch handle 602 should allow the finger tips to touch the latch handle such that fingertips can exert sufficient force to move the latch handle 602.

Continuing with FIG. 9, the latch portion 606 is located at the base of the arch 110. The arch 110 defines openings 160, 162 for receiving the portion of the latch system located on the backplate 112.

The latch pins 134, 136 are the second portion of the latch system 140 and are located on the backplate 112. In this illustrative case, the latch pins 134, 136 extend outwardly from both sides of the tabs 142, 144 and are generally parallel one to the other.

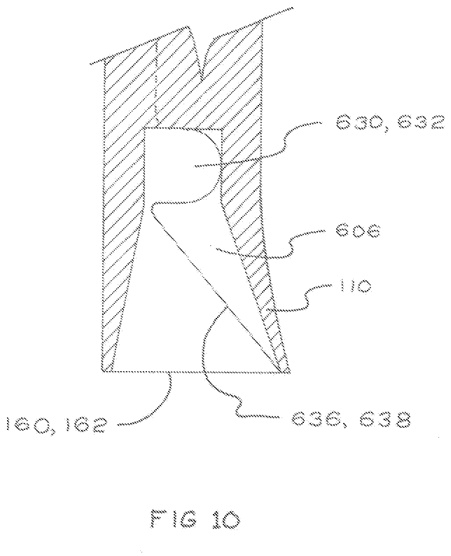

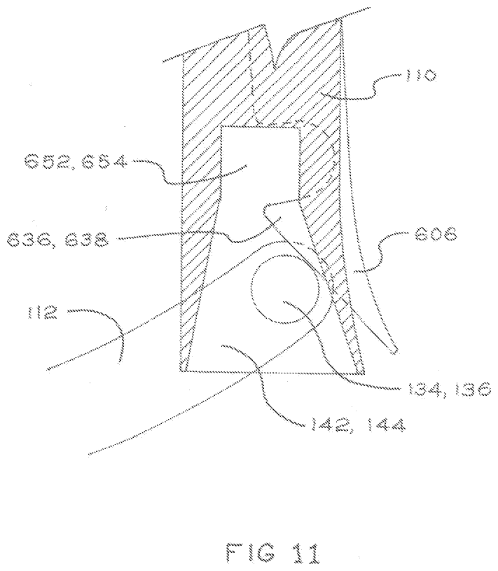

As shown in FIG. 9, a latch pin 134, 136 enters the opening 160, 162 in the arch 110 and is secured under that latch portion 606. The engagement of the latch portion 606 with a latch pin 134, 136 is illustrated in FIGS. 10, 11, and 12. As shown in FIG. 10, the latch portion 606 is in its normal position without the backplate 112. The latch portion 606 is biased in this position by a spring 626 (see FIG. 6) acting on an abutment 628 projecting outwardly from the mid-section 604. As illustrated in FIGS. 1, 2 and 3, an outside surface 628 of the latch portion 606 defines a portion of the outside surface of the arch 110.

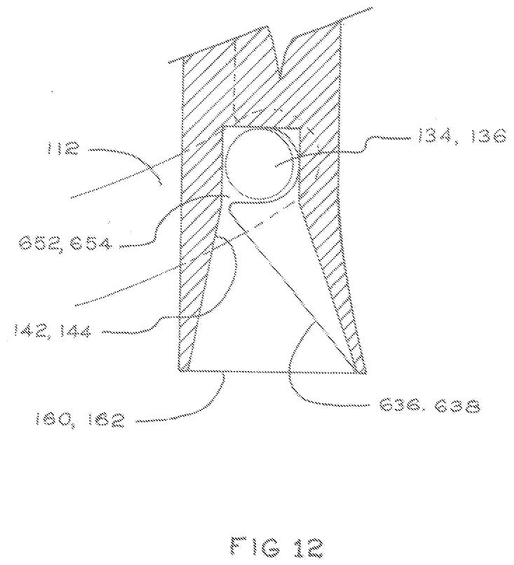

Continuing with FIG. 11, the latch pin 134, 136 engages the latch portion 606 on a contact surface 650. This engagement causes rotation of the latch portion 606 outside the arch 110, clearing an entry way into a seat 652, 654. As shown in FIG. 12, after the latch pin 134, 136 enters the seat 652, 654, the latch portion 606, which has detents 630, 632, secures the latch pin.

The entry from the opening 160, 162 to the seat 652, 654 may be flared and contoured. Flaring controls the precision needed for placing the latch pin 134, 136 within the opening 160, 162. Contouring controls how the latch pin 134, 136 travels once within the opening 160, 162.

It should be appreciated placement of a latch pin 134, 136 into an opening 160, 162 will be a “blind” placement, as a user is placing the opening over a latch pin. As a result, the greater in area the opening 160, 162 is the easier it will be to attach the arch 110 to the backplate 112.

As shown in FIG. 9 in this illustrative example, flaring is provided both longitudinally and laterally within the opening 160, 162. Longitudinal flaring is provided by a first contoured surface 902. Lateral flaring is provided by cooperating second and third contoured surfaces 904, 906. These contoured surfaces define the flare by creating an opening that is larger than the opening that would have otherwise been defined if the surfaces of the seat 652, 654 where extended.

The contouring guides the relevant latch pin 134, 136 within the relevant opening 160, 162 to the relevant seat 652, 654. In this illustrative example, there is sufficient contouring such that as the ends of the latch pin interacts with contouring the tab 142, 144 are prevented from contacting any of the surfaces that define the opening and seat. The contoured surface 910, which does not guide a pin end, is provided to avoid having the tab 142, 144 contact any surface due to the play permitted by the other contoured surfaces. After the latch pin is secured, the tab 142, 144 of the backplate 112 is in the cavity 634 and not touching the latch portion 606.

The contouring of the opening, the contact surfaces 636, 638 of the latch portion 606, and the spring bias applied to the latch portion cooperate to determine the ease by which the latch pins 134, 136 will slide into the seat 652, 654. It is desirable to make the force required to engage the latch pins 134, 136 relatively consistent. A relatively constant force can be achieved by maintaining, or minimizing the change in, the angle of attack of the latch pins 134, 136 on the bearing surface 636, 638. In this case, the bearing surface 636, 638 is given an outward curvature to minimize the change in the angle of attach as the latch pins 134, 136 are inserted.

It should be appreciated that since both the latch portion 606 and latch handle 602 pivot about the axle 616, the latch portion, without displacing the latch handle, can be displaced by grasping a bottom edge 656, 658 of the latch portion. As a result, the latch 600 can be disengaged from the latch pin 134, 136, permitting the backplate 112 to be disconnected from the arch 110, by pulling outwardly on the bottom edge 655 of the latch portion 606. More specifically, pulling on the bottom edge 655 causes the latch portion 606 to rotate about the axle 616. Thus, if the latch handle 602 cannot be rotated inward, such as if the victim's body prevents it, the arch 110 can still be disconnected from the backplate 112.

This latch design permits either latch to be disengaged by pushing the latch handle 602 inward or grasping of the bottom edge 655 and pulling it outward, or one latch to be disengaged as describe above and the other latch to be disengaged by rotation of the arch 110 about the still connected latch pin 134, 136, creating a multi-disengagement latch. A “multi-disengagement latch” as used herein means a latch that has more than one non-destructive mechanism by which it can be disengaged. More specifically, as the arch 110 is rotated about a latch pin 134, 136 the bottom surface of the backplate 112 impacts the bottom edge 655 of the latch forcing it outward causing it to disengage. Disengaging a latch by rotation offers the advantage of easy removal of the arch 110 from the backplate 112 by rotating arch about the victim instead of having to reach over the victim and pick the arch straight up over the victim.

Compression System

The compression system 200 provides the movement necessary for the CPR Device 100 to provide CPR to a victim. As shown in FIG. 1, the compressions system 200 is mounted to the arch 110. The compression system 200 incorporates a drivetrain (generally referred to as 201) having a motor 210, drive 209 and a ram 220. In this illustrative example, drive 209 is a linear drive and more precisely a linear actuator of the ball screw type, due to its low friction characteristics. The drivetrain 201 is mounted to a housing 203, which acts as a foundation.

When the compression system 200 is secured in the arch 110, the CPR pad 204 is positioned such that it will be above and generally centered on the sternum of a victim positioned within the opening 106. As illustrated, the motor 210 is positioned above the arch 110 with the drive 209 and ram going through the bore 207.

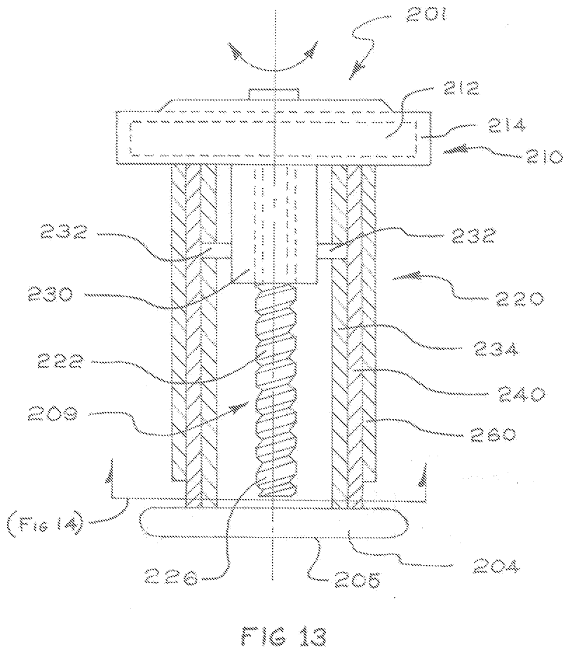

FIG. 13 is a drawing of an illustrative motor. The illustrated motor 210 is an “out-runner,” but other motors could be used. In this style of motor, the rotor 214 rotates outside of the stator 212.

As shown in FIG. 13A, the rotor 214 has a center hub connected by spokes to an outer ring. It is possible to give the spokes a wing shape (e.g., mean camber equal to or greater than 0, twist, and angle of attach), such that the rotor when rotating acts as a fan.

In this illustrative case, the motor is a DC motor; thus, rotational direction of the rotor 214 is controlled by the polarity of the power supplied to the stator 212.

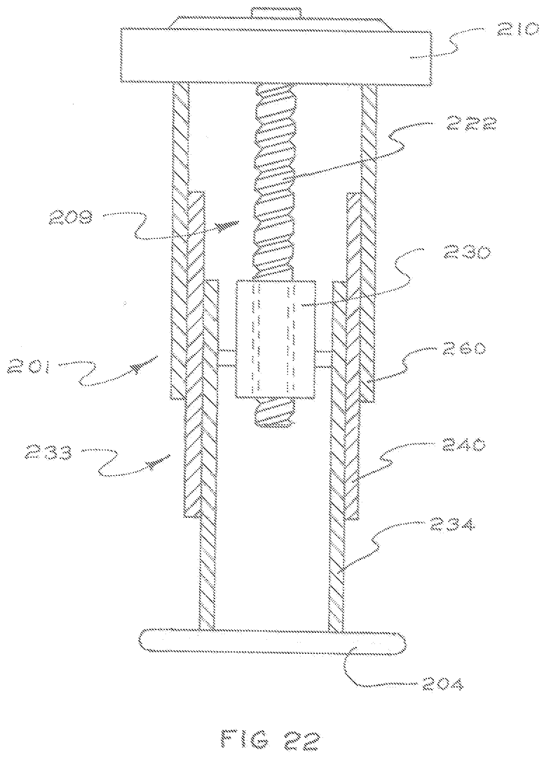

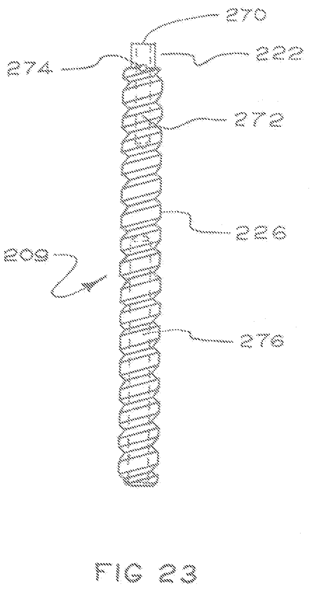

Referring to FIGS. 22 and 23, the drive 209 has a driveshaft 222 that connects to the motor's 210 rotor 214.

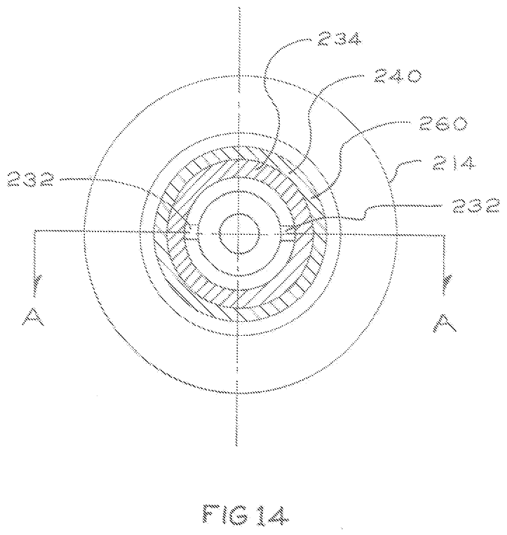

Continuing with FIGS. 13 and 14, the nut 230 rides on the thread portion 226 of the drive 209. The nut 230 is rigidly secured by one or more connectors 232 to an inner sleeve 234 of the ram 220. The connection system is a matter of design choice and may be permanent or allow for non-destructive disconnection. Some suitable connectors are pins, screws, or rivets.

The inner sleeve 234 of the ram 220 has a distal end. In this illustrative example, the distal end 205 is defined by an outer surface of a CPR pad 204. Thus, as the nut 230 travels along the thread portion 226 of the driveshaft 222, the distal end 205 moves. The distal end 205 completes one stroke by the nut 230 moving down the threaded portion 226 and then being retracted by moving up the threaded portion.

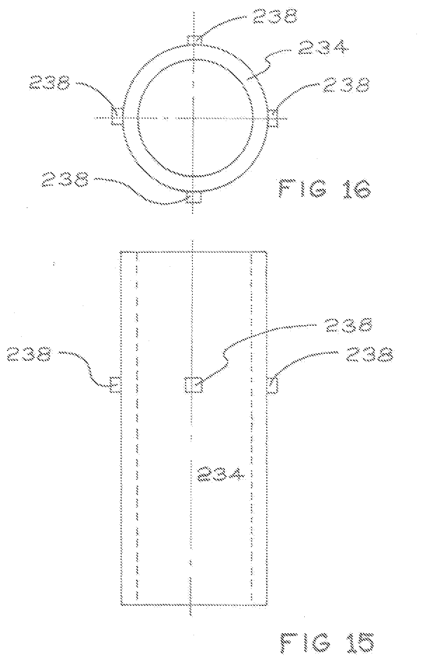

Referring to FIGS. 15 and 16, the inner sleeve 234 has attached to and projecting outwardly therefrom cooperating rollers 238. In this illustrative example, there are four rollers with one positioned at 0, 90, 180, and 270 degrees.

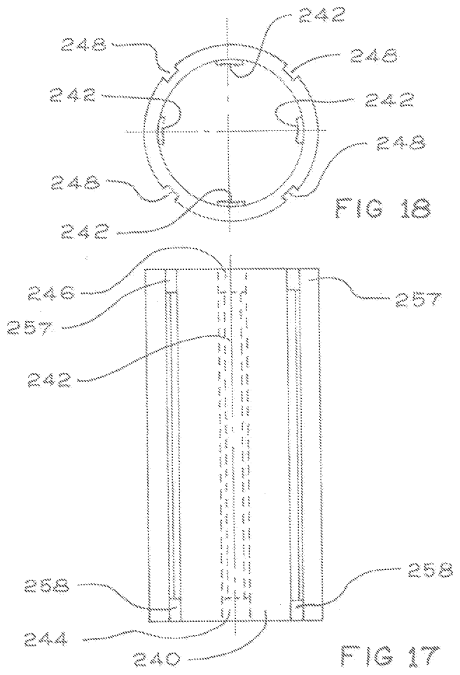

Referring to FIGS. 13, 17 and 18, the inner sleeve 234 is positioned within a telescoping sleeve 240. As shown in FIGS. 17 and 18, the telescoping sleeve 240 defines inner channels 242 on the inside. At least one roller 238 on the inner sleeve 234 is placed in the appropriate inner channels 242. In this illustrative example, each roller 238 has an inner channel 242. The rollers 238 should roll in an orientation that allows them to move along the inner channel 242.

Positioned within at least one channel 242 is a bottom stop 244 and within at least one channel, which may be the same channel, an upper stop 246. The function of the stops is discussed below.

The telescoping sleeve 240 of the ram 220 also has at least one outer channel 248. The illustrated outer channels 248 are offset 45 degrees from the inner channels 242. Similarly to the at least one inner channels 242, there are outer upper stop(s) 257 and outer lower stop(s) 258.

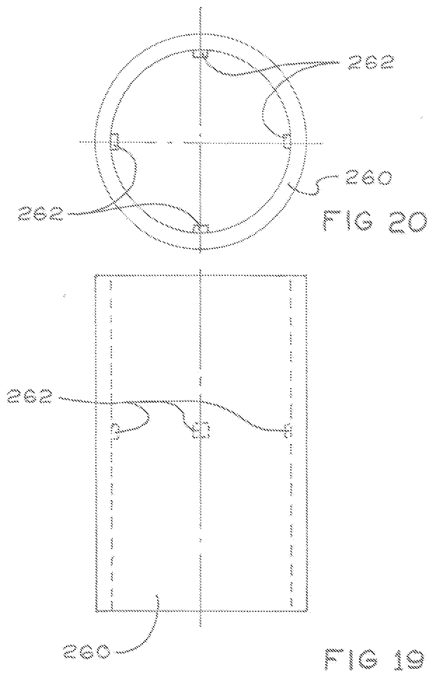

Referring to FIGS. 13, 19, and 20, the telescoping sleeve 240 is inserted into an outer sleeve 260. As shown in FIG. 19, the outer sleeve 260 has at least one inwardly projecting tab 262. The tab(s) 262 are inserted in respective outer channels 248 of the telescoping sleeve 240.

It should be appreciated by those skilled in the art, that the structure for the telescoping sleeve 240 could be repeated such that there is more than one telescoping sleeve.

Any rotation of the inner sleeve 234 is not desirable. In the illustrated example, a torque transfer system from the nut 230 to the outer sleeve 260 is provided by the linkage system from the nut to the inner sleeve 234, from the inner sleeve to the telescoping sleeve 240, and from the telescoping sleeve to the outer sleeve 256. More precisely, the connector 232 and the edges of the inner and outer channels 264, 266 interacting respectively with the sides of the rollers 236 and the tabs 246.

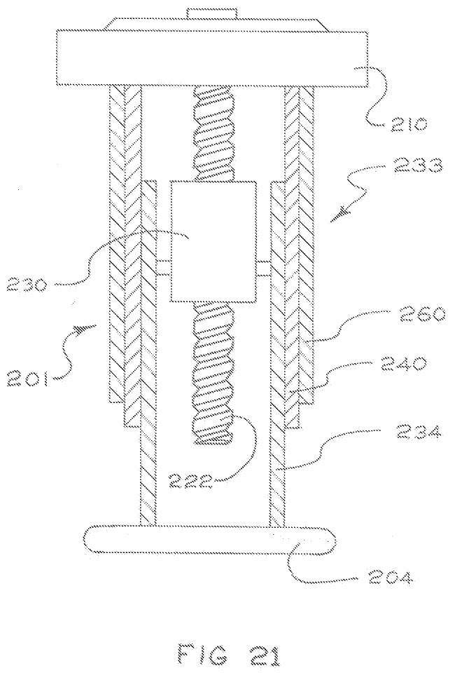

FIGS. 13, 21, and 22 depicts the interaction of the various sleeves—inner sleeve 234, telescoping sleeve 240, and outer sleeve 260—of the ram 220. In FIG. 13, the inner sleeve 234 is not extended. In FIG. 21, the inner sleeve 234 has been extended but not sufficiently enough to cause a roller 238 on the inner sleeve 234 to impact a bottom stop 244 on the telescoping sleeve 240. As a result, the telescoping sleeve 240 remains in position due to the friction created by tabs 262 on the outer sleeve 260 within outer channel 248. In FIG. 21, the inner sleeve 234 has been extended sufficiently to cause a roller 238 to impact a bottom stop 244 and providing sufficient energy to overcome the friction created by the tabs 262 thereby extending the telescoping sleeve 240. This procedure when reversed (upper stop 246 instead of bottom stop 244) will cause the telescoping sleeve 240 to retract.

It should be appreciated that the telescoping sleeve 240 permits the nut 230 to act as a lower bearing for the driveshaft 222. As a result, an intermediate bearing between an upper bearing and a lower bearing is avoided. For the nut 230 to be an effective lower bearing the overlap of the telescoping sleeve 240 relative to the inner sleeve 234 and the outer sleeve 260 must be sufficiently ridged. An overlap of 4 to 1 (length remaining with a sleeve to extension) is suitable.

It is desirable that the diameter of the telescoping sleeve 240 not exceed the diameter of the CPR pad 204, such that the telescoping sleeve is concealed above the CPR pad. It, also, should be appreciated that while the various sleeves have been described is cylindrical terms, this is not a requirement of the invention, and the use of cylindrical terms herein should not be considered limiting unless expressly stated as limiting.

Continuing with FIG. 23, the driveshaft 222 has an orifice 270 leading to an oil sump 272. Above the bottom of the oil sump 272, is a passage 274 to permit oil to exit the oil sump and lubricate the thread portion 226. The passage 274 is placed below the motor but above the upper most position of the nut 230. Oil is put into the oil sump 272 through the orifice 270. The driveshaft 222 also is lightened by a centerline bore 276.

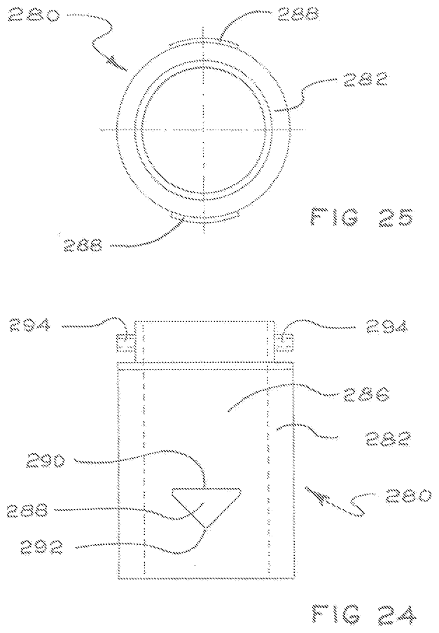

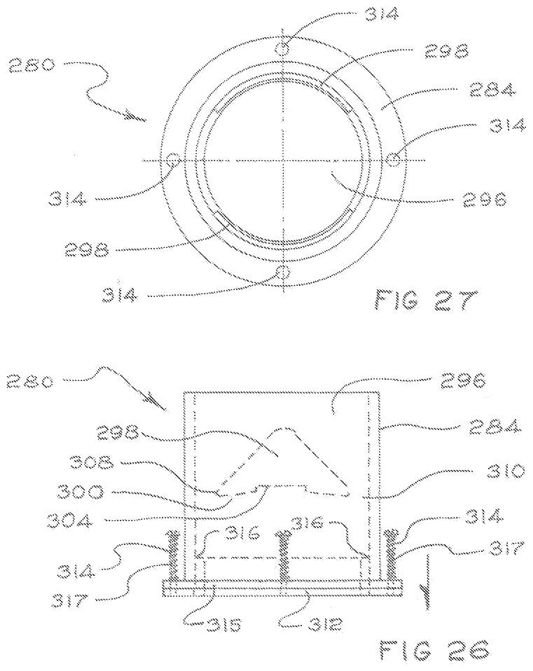

In this illustrative example, the compression system 200 is removable from the arch 110. More precisely, at least a portion of the housing 203 of the compression system 200 is inserted in the arch 110 in a through bore defined by the arch and held therein by a first mount (generally referred to by reference number 280). As shown in FIGS. 24, 25, 26, and 27, the first mount is of the quick-disconnect style, a quarter-turn type, that includes an insert 282, FIGS. 24 and 25, integrated into the compression system 200 that engages a lock 284, FIGS. 26 and 27, that is integrated into the arch 110.

Continuing with FIGS. 24 and 25, the insert 282 defines a thru-bore 286 through which the ram 220 is positioned. More precisely, the outer sleeve 256 of the ram 220 is placed in the thru-bore such that the motor is on one side of the insert 282 and the CPR pad 204 is on the other. The outer sleeve 256 of the ram 220 is secured to the insert 282. In this illustrative case, it is permanently connected (i.e., destructive disconnection), but it could be by temporary fasteners, such as screws, which would allow non-destructive removal.

Positioned on the outer surface of the insert 282 is a pair of keys 288. The keys 288 are generally triangular having a base 290 and apex 292, which points in the direction of the CPR pad 204.

The insert also includes a pair of bosses 294 that provide the connection between the insert 282 and a housing 203 (see FIG. 1).

Continuing with FIGS. 26 and 27, the insert 282 is dimensioned to slide into a bore 296 defined by the lock 284. On the surface of the bore 296, is a pair of keepers 298. The keepers 298 are generally triangular with the apex pointing at the opening in the bore 296 through which the insert 282 will be inserted. The keepers 298 are positioned such that they are not touching; thus defining a number of gaps equal to the number of keepers. Each gap should be only slightly larger (i.e., just wide enough to let the key slip between the keepers) than a key 288, as it is desirable to have a key impact a keeper 298 upon insertion of the insert 282 into the housing 203.

The base 300 of the keepers 298 define a notch 304 dimensioned to accept the base 290 of the key 288. The base 290 on either side of the notch 304 is curved toward the apex, such that the base vertices 308, 310 are “below” the notch entrance.

At the base of the thru-bore 286 is a flange 315 that interacts with a bias plate 312. More specifically, the bias plate is secured by a pin 317 running through each at least on spring 314. The pin 317 passes through the flange 315 and connects to the bias plate 312, which effectively traps the at least one spring 314 between the top of the pin and the flange.

The bias plate 312 has an inner surface 316 within the thru-bore 286, which is dimensioned to be impacted by the insert 282 when it is inserted. Prior to the insert 282 impacting the inner surface 316, the at least one spring 314 is in compression causing the bias plate 312 to be held firmly in place against the bottom of the flange 315 on the lock 284. When impacted by the inner surface 316, the pin 317 by movement of the bias plate, to which the pin is connected, acts to put the at least one spring 314 in further compression.

Upon insertion of the insert 282 into the lock 284, the keys 288 will impact a keeper 298; assuming placement does not put them in a gap. Upon impacting the keeper 298, the insert will rotate (in this design rotation can be either clockwise or counter-clockwise) as the apex of the key slides down an edge of a keeper. As the apex of the key 288 passes a base vertex of a keeper 298, insertion of and rotation of the insert continues until the base 290 of the key passes a base vertex of the keeper; thus causing the further compression of the at least one spring 314 to be released thereby self-locking the compression system 200 to the arch 110.

At some point during the insertion of the insert 282 before the base 290 of the key 288 passes a base vertex of the keeper 298, the bottom edge of the insert will impact the bias plate 312 causing the at least one spring 314 to extend. At the point where the key 288 passes a base vertex 308, 310, and with continued rotation of the insert 282, the bias plate 312 will begin to force the key to maintain contact with the keeper 298 until such point that the upper base 290 of the key is securely within the notch 304. To disengage, the procedure is performed in reverse beginning with pushing the insert 282 toward the bias plate 312 to cause the key 288 to disengage from the keeper 298.

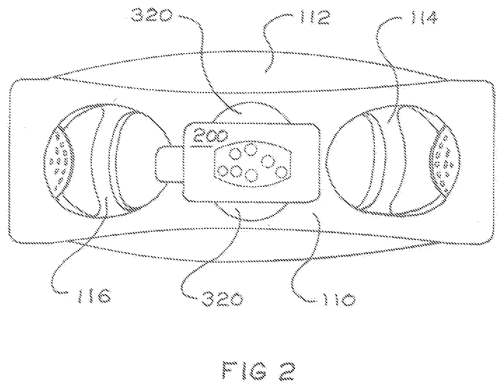

Referring to FIG. 2, insertion of the compression system 200 into the arch 110 may be accomplished using second handles 320 positioned on the housing 203.

It should be appreciated that in operation compressive force exerted by the downward movement of the CPR pad 204 will cause the support assembly 102 to flex. Referring to FIG. 1, the opening 106 will be distended by the movement of the top portion of the arch 110 away from the backplate 112. As a result, the support assembly 102 should have sufficient structural integrity to limit this distention, for example to no more than about ⅜^{ths} of an inch during a CPR stroke.

Control System

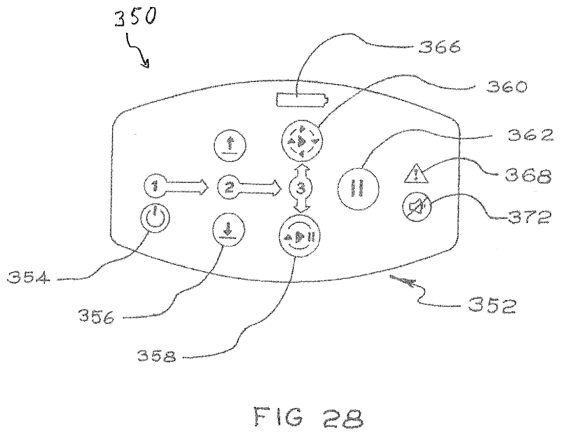

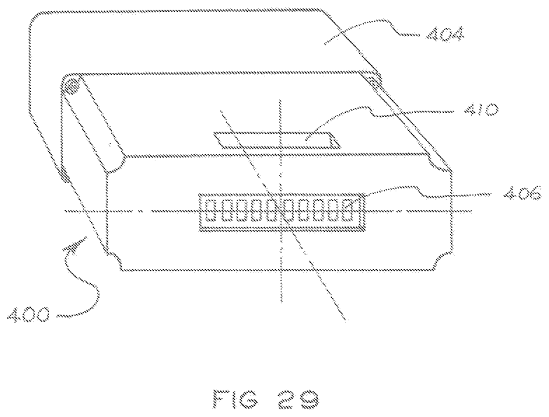

Continuing with FIG. 28, a user interacts with the compression system 200 using a control system 350. The control system 350 comprises a hardware processor and a memory in which programming in the form of computer-executable instructions is stored for execution by the hardware processor. The control system 350 also includes a control panel 352 that permits a user to interact with the control system 350.

The illustrative control panel 352 includes control over the functions of on/off switch 354, CPR pad adjustment control 356, CPR start switch 358, CPR stop switch 360, and CPR pause 362. Also, control panel 352 includes an on/off control over an audio system 372, and a battery status indicator 366.

To operate the compression system 200, a user turns ON the control system 350 by changing the status of the on/off switch 354. When the control system 350 is turned ON, the control system may locate the CPR pad 204 in a known position or obtain the position, referred to as an initial position. The initial position permits the control system 350 to achieve the desired depth of compression.

At this time, a system self-test might also occur, or the results of a self-test conducted while in the OFF state might be reported. In the case of a self-test occurring upon startup, or a previously conducted self-test, such as one conducted in the OFF state, the results are indicated using perceptible, visual, tactile, or audible, output. In this illustrative example, a visual output 368 (e.g. light) is used, which illuminates if the compression system is not functioning properly. The system could also function in reverse with the visual output illuminating if the compression system was functioning properly. In addition, there could be a distinct illumination for either operational condition.

The compression system 200 next places the distal end 205 of the CPR pad 204 into a therapeutic position. The therapeutic position is defined as a start position from which CPR can be effectively delivered (i.e., sufficiently compress the sternum). The spatial difference between the initial position and the therapeutic/start position is the offset.

The therapeutic position places the distal end 205 into firm contact with the victim's chest. One method to accomplish this placement is to direct the motor 210 to place the distal end 205 of the CPR pad 204 into contact with the chest such that a pressure between about 11 to 13 kg, with about 12.25 kg being a reasonable amount, is exerted on the chest. Then, put the drivetrain 201 in neutral permitting that distal end 205 to freely change position. In the neutral position, the compressed chest pushes back against the distal end 205 causing the distal end to be retracted (i.e., displaced toward the initial position) until the chest and compression system 220 are in equilibrium. The point at which the distal end 205 comes to rest is the therapeutic position. It should be appreciated that to assure that at the therapeutic position the distal end 205 is in firm contact with the chest (compress the skin but not the sternum), a minor displacement in the equilibrium position, thus the therapeutic position, toward the chest could be made, which would generate minor, but insignificant, pressure on the chest.

The control system 350 may automatically detect the therapeutic position employing a position detection controller such as a proportional integral controller (PI controller). In an illustrative example, the PI controller monitors the speed of descent of the CPR pad 204 from the initial position toward the therapeutic position. During descent, an initial voltage applied to the motor 210 is a fraction of that needed to administer CPR. While a matter of design choice, the initial voltage must be less than a voltage needed to perform CPR, a maximum voltage of around 50% is acceptable, but greater than zero, voltage around 10-17% is a practical minimum. When the CPR pad 204 initially contacts a chest, the resistance of the chest will cause the speed of descent of the CPR pad 204 to slow, or stop if at maximum voltage. In the event the maximum voltage is not being applied to the motor 210 at initial contact, the voltage applied to the motor is increased (i.e., to a voltage proportional to the error in the PI) in an attempt to cause the CPR pad 204 descent to continue. When the maximum voltage is reached and the descent does not continue, the CPR pad 204 is considered in the therapeutic position. The initial position and the therapeutic position can be stored in the memory of the control system 350. It should be appreciated that similar procedures for detecting resistance in the downward motion of the CPR pad 204 can be used to determine the therapeutic position.

The CPR pad adjustment controls 356 permit the CPR pad 204 (see FIG. 13), to adjusted both toward and away from a victim's chest, to manually adjust the therapeutic position.

Once the CPR pad 204 is in the therapeutic position, CPR compressions can begin. CPR compressions are initiated by a CPR start switch 358. CPR compressions are terminated by a CPR stop switch 360. When the CPR stop switch 360 is depressed, the CPR pad 204 is repositioned to a stored position, which could be the initial position.

CPR compressions can also be paused by changing the status of a CPR pause button 362. When CPR compressions are paused, the CPR pad 204 remains in a position suitable to continue CPR compressions when the pause is terminated. More specifically, the CPR pad could be somewhere in the current CPR stroke, or automatically repositioned back to the current therapeutic position. It could also be possible to automatically relocate the CPR pad back to some other position because the current therapeutic position is stored in the memory such that when the pause is released the CPR pad automatically returns to a suitable position to resume compressions.

The control system 350 may permit control over the depth of the compressions. For example, as the offset (the distance between the initial position and the therapeutic position) is increased the depth of compression may decrease. The recommended compression depth is 5 cm, but there is an inverse relationship between the offset and the victim size. More precisely, as the offset increases the victim is getting smaller (i.e., the victim's cross-section in the thoracic region is decreasing). As a result, the standard compressive depth of 5 cm could be too great.

There are numerous ways that variable compression depth could be implemented. It could be automatic, such that the therapeutic position determines compression depth. Alternatively, there could be user adjustment, such as through the control panel 352. The system could also be user activated or deactivated, for example by a button (not shown) on the control panel 352.

The control system 350 may also have the capability to adjust the previously discussed therapeutic position for subsequent CPR strokes. Continuous adjustment of the therapeutic position throughout a CPR session permits the portion of the ram 220 that contacts the victim to maintain better proximity to the victim's chest, minimizing or eliminating gaps that have the potential to cause patient injury. The continuous adjustments of the therapeutic position may occur periodically (e.g., every stroke, some number of strokes) or randomly. The adjustments could be based on a cumulative analysis of the CPR strokes, a series of strokes, analysis of some strokes, or a stroke.

Where the therapeutic position is adjustable, the therapeutic position initially set at the “start position” for the first CPR stroke (discussed above) is referred to as the initial therapeutic position with subsequent CPR strokes in the CPR session commencing at a beginning therapeutic position.

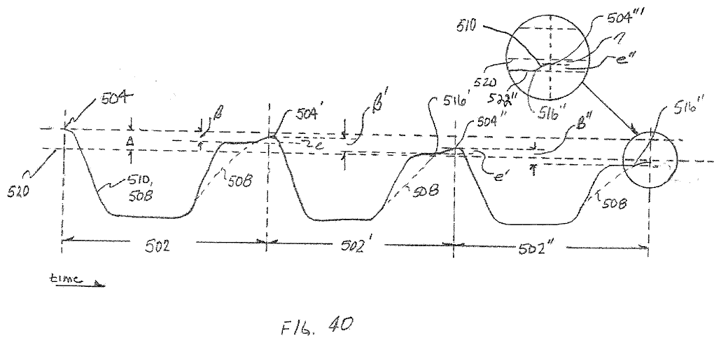

FIG. 39 is an illustrative example of a CPR stroke 502 provided by the CPR device 100. A CPR stroke 502 has a compression segment, a hold segment, and a release segment. The CPR stroke occurs over a duration t, based on the recommended rate for CPR (compressions/minute). As a CPR stroke is based on time, the compression of the chest begins at a beginning therapeutic position 504 and ends at a next beginning therapeutic position 504′. It should be appreciated that if the CPR stroke was the first CPR stroke in a CPR session, the stroke would begin at the initial therapeutic position.

The figure provides a chest trace 508 and a ram trace 510. The chest trace depicts the position of the chest as the chest is compressed and allowed to decompress during the CPR stroke 502. The ram trace represents the position of that portion of the ram, which is part of the compression system 200, that contacts the chest (generally referred to as the “CPR surface”). Thus, the ram trace shows the path followed by the CPR surface as the ram depresses and releases the chest. In this illustrative example of the CPR device 100, the CPR surface is the distal end 205 of the CPR pad 204 of the ram 220.

Adjustment of the therapeutic position is accomplished as follows. The CPR stroke 502 begins at a beginning therapeutic position 504. As the compression segment of the CPR stroke begins, the chest trace 508, and ram trace 510 are coincidental. The chest and ram traces remain coincidental through the compression segment and hold segment of the CPR stroke. Also, when the release segment of the CPR stroke begins (point A), the chest and ram traces are still coincidental. As those skilled in the art of mechanical CPR will appreciate, the term “coincidental” as used herein is not intended to mean in constant contact with constant force, but it is intended to mean constant contact with any force.

At point B, the ram and chest traces 508, 510 diverge as the ram releases the chest thereby permitting the chest to decompress naturally. Programming in the form of computer-executable instructions stored in the memory and executable by the hardware processor of the control system 350 causes the motor 210 driving the ram 220 to cause the CPR surface to release the chest. In other words, the rate at which the motor retracts the CPR surface exceeds the decompression rate of the chest.

As indicated by the ram trace 510, the CPR surface is retracted to a contact level 522 to await contact from the decompressing chest at a contact point 516. The contact point is the point at which the chest trace 508 intersects the contact level. The contact level is a pre-determined distance β below the beginning therapeutic position 504 of the CPR stroke where β can be determined based on an analysis of one or more prior CPR strokes.

Continuing with FIG. 39, upon the CPR surface reaching the contact level 522, the control system 350 programming puts the drivetrain 201 in a rest state. The “rest state” of the drivetrain 201 is defined as a state wherein the drivetrain has a minimal non-zero bias. The minimal non-zero bias is ideally a force that is less than the force the decompressing chest will exert on the ram upon contact with the ram, so the ram will move after being contacted by the chest, but no greater than the minimum force required to keep the CPR surface, after contact with the chest, in contact with the chest as it continues to decompress. In other words, the minimal non-zero bias should only minimally decrease the decompression rate of the chest.

It should be appreciated, the present invention in use may be subject to external forces, such as vertical acceleration from a vehicle in which the invention is being used, and prudent determination of the minimal non-zero bias should account for these forces. More specifically without sufficient bias, the CPR surface could bounce on the chest due to the external forces, which would be undesirable. As those skilled in the art will appreciate, consideration of those forces could cause the minimal non-zero-bias to be greater than optimal. If external accelerations applied to the system cause the CPR surface to go over the initial therapeutic position, the control system may counter act the motion by applying brakes, using the motor as an inductive brake, or by driving the motor.

There are several ways to put the drivetrain 201 in a rest state. A first method would be to put the motor that drives the ram in a floating state (i.e., the motor adds no added friction to the drivetrain) and let the friction inherently present in the drivetrain act as the bias. Where the friction in the drivetrain is insufficient to assure contact of the ram with the decompressing chest, bias could be added (i.e., added bias) using the motor (e.g., actively driving the motor or using it as an inductive brake), or other friction generating devices, such as brakes.

Upon the decompressing chest reaching the contact point 516, the control system 350 detects the contact, such as by movement of the CPR surface or capacitive detection. Where a motor is directly connected to the ram, the control system could detect chest contact with the ram by rotation of the motor. Other possible methods for the control system to determine this contact would be sensors mounted on the ram.

When the control system directs the start of the next compression stroke, the control system records the next beginning therapeutic position 504′. More specifically, the CPR stroke has a pre-determined duration and will begin automatically thereby determining the next beginning therapeutic position 504′. As will be discussed below, the next beginning therapeutic position is used to determine that stroke's contact level.

Where the decompressing chest has at least reached the contact point 516, the next beginning therapeutic position 504′ will either be at the contact level 522 or a distance c above the contact level. In the event the chest fails to reach the contact level, the next beginning therapeutic position will be set at the last contact level. In the event this occurs, computer executable instructions stored in the control system 350 can provide a user alert and possibly cease CPR.

A beginning therapeutic position preferably should be in a band defined by the initial therapeutic position and an effective CPR level 520, which is a distance Δ below the level defined by the initial therapeutic position. The effective CPR level is generally understood by those in this field and is defined as a level below which the ram will not provide a compressive distance as to the chest which is considered an effective depth for providing CPR. In the event that a next beginning therapeutic position is higher than the level defined by the initial therapeutic position or lower than the effective level, the computer executable instructions can cause the control system 350 to generate a user alert and potentially cease CPR.

The control system 220 may have computer-executable instructions to detect trends in CPR strokes. For example, if the control system 350 detects chest movement but the beginning therapeutic position continues to move in the direction of the backboard, the control system could provide a user alert.

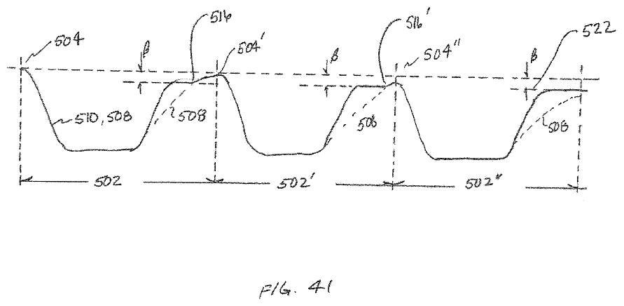

FIG. 40 illustrates three CPR strokes, with the first stroke occurring after the initial therapeutic stroke, and an adjusting contact level 522. These three CPR strokes illustrate the case where a chest is not returning to the beginning therapeutic position. More specifically, for each stroke the chest reaches an ever-decreasing state of decompression.

In the first stroke 502, the compression starts at a beginning therapeutic position 504. The control system 350 sets the effective level 520 at a location Δ below the beginning therapeutic position. The control system 350 sets the contact level 522 at a location β below the beginning therapeutic position. The traces of the chest 508 and ram 510 indicate that the chest decompresses to the contact point 516 and beyond up to a next beginning therapeutic position 504′. The next beginning therapeutic position, however, is below the beginning therapeutic position 504.

Since the second CPR stroke 502′ has a beginning therapeutic position 504′ that is different than the prior first CPR stroke 502 beginning therapeutic position 504, the control system resets the contact level 522 to a new, and in this case, lower contact level 522′. It should be noted that for this second CPR stroke, the contact point 516′ is still above the effective level 520.

At the conclusion of the second CPR stroke 502′, the chest reaches the contact point 516′ and the control system 350 sets a next beginning therapeutic position 504″ for the third CPR stroke 502″. For CPR stroke three, however, the new contact level 522″ is below the effective level 520. As a result, there is now a distance η that the chest must decompress to reach a position above the effective level 520, to assure effective CPR can be delivered. As illustrated, the chest does reach the contact point 516″ but fails to reach a level above the effective level 520, and as a result the control system can provide a user alert and possible cessation of CPR.

FIG. 41 illustrates another detection embodiment where the contact level 522 is set based on the initial therapeutic position 504 and remains fixed throughout the CPR session. The figure depicts three CPR strokes 502 where the chest decompression is decreasing. In this example, at the end of the third CPR stroke 502″ the chest failed to decompress sufficiently to reach the contact level 522, resulting in the control system providing a user alert and possible cessation of CPR after one or more consecutive occurrences.

While the above examples illustrate the case of a decreasing decompressing chest, the method and apparatus should not be limited to use only in these cases. The therapeutic position can change upward or downward over time, ideally moving within a band defined by the initial therapeutic position and the effective level 520. It could also be permitted to move outside the band, but if it does so, suitable user alerts should be provided.

A battery meter 370 is also provided. The battery meter 370 provides a visual indication of the charge status of the battery.

Computer executable instructions stored in the memory of the CPR control system 350, may include audio assistance in using the device. The on/off switch 372 controls output of the audio assistance through a speaker (not shown).

The CPR control system 350 may also include a visual status indicator 368, in this illustrative case a light, to indicate the operational status, functioning and/or malfunctioning, of the device. A speaker if available could also be used (e.g., a chirp in the event of a malfunction). The status could be obtained from self-tests, either performed automatically when the CPR unit is OFF, upon startup, or upon user direction.

Power System

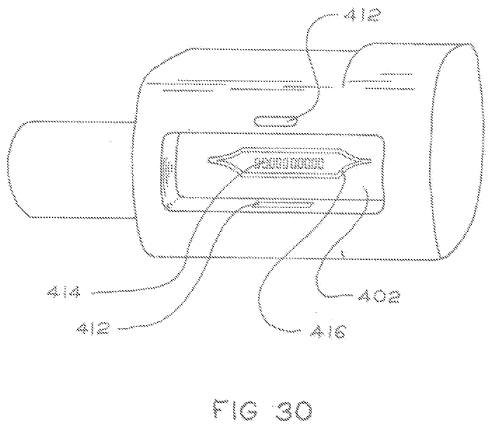

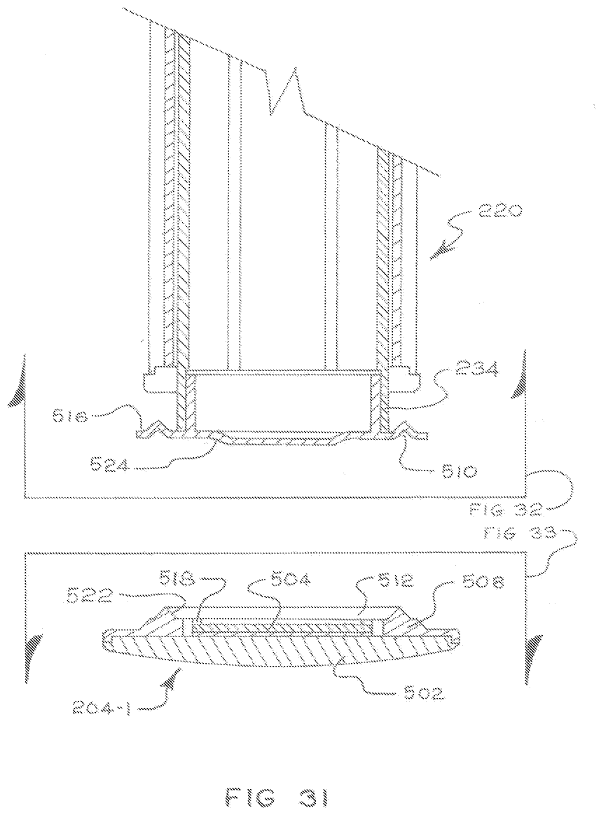

Referring to FIGS. 29 and 30, the compression system 200 and control system 350 are powered by a power system power system 400, as illustrated a battery pack that which inserts into a power system slot 402. The power system 400 has a certain number of cells, individual or unified multi-cell, based on the capacity needed, which cells may be rechargeable.

Continuing with FIG. 29, the power system 400 has an outer case 404 that is dimensioned to fit into the power system slot 402. As shown in FIG. 1, only a portion of the outer case 404 fits within the power system slot 402 with the balance creating a gripping portion.

The power system 400 further has one-half of an electrical connector 406, comprised of a series of individual connectors 408, located on the bottom. The electrical connector 406 is symmetrical about the centerline lines of the power system 400. In addition, the power system 400 has tabs 410 (one on each side), symmetrically located about a centerline, which is shared with the electrical connector 406.

As shown in FIG. 30, latches 412, which are spring biased, generally simultaneously engage tabs 410 to secure the power system 400 in the power system slot 402. The power system slot 402 also has complementary connector 414 to the electrical connector 406 on the power system 400. A spring 416 is also provided. By insertion of the power system 400 in the power system slot 402, the spring 416 is compressed permitting the spring to assist in battery removal when the latches 412 are released.

The symmetry of the outer case 404, the latches 412, the electrical connector 406 and the complementary connector 414 permits the power system 400 to be inserted in the power system slot 402 in more than one orientation, two in this illustrative example.

Optionally, power can be provided by a line voltage source.

Accessories

As discussed above, the CPR Device 100 may have a CPR pad 204. Where it is intended that the outer surface of the CPR pad 204 touch a victim, the CPR pad should be replaceable. Temporary attachment could be by a quick-disconnect second mount such as snap-on, magnets, hoop and loop fastener, etc.

Generally, the material for the CPR pad 204 is a matter of design choice but should be generally non-compressible, or minimally compressible, so it does not interfere with the compressing action of the device and the outer surface should be of a material that provides some friction when in contact with skin or clothing to aid in maintaining the position of the ram 220 on the sternum (e.g., avoid sliding).

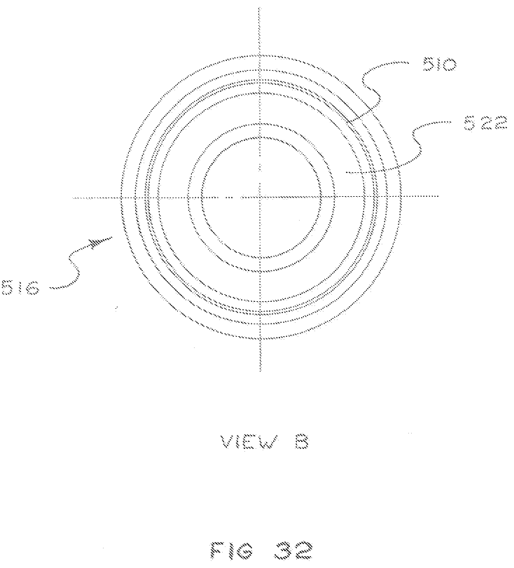

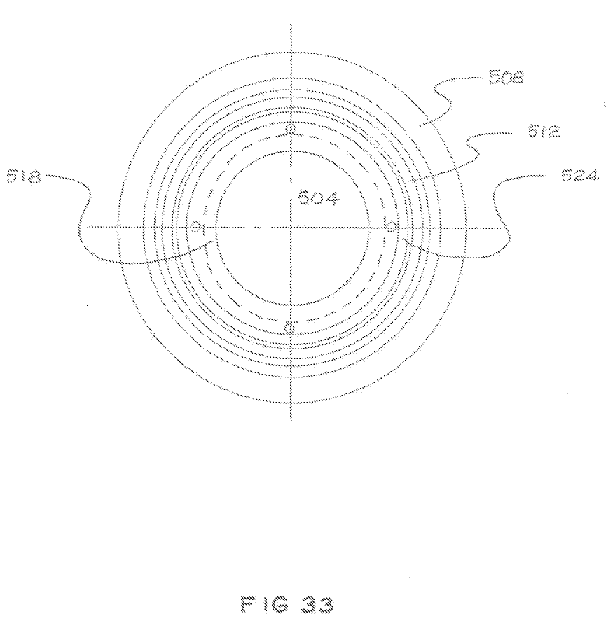

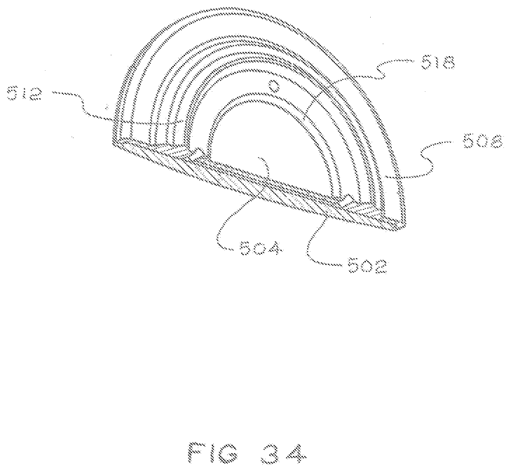

A first embodiment of CPR pad 204 is shown in FIGS. 31, 32, 33, and 34, generally referred to by reference number 204-1. The CPR pad 204-1 includes a frame 508 having a pad 502 mounted thereon.

The CPR pad 204 is made from a soft material to allow the pad 502 to adopt a contour consistent with the sternum. It should be noted that the pad 502 extends to the edges to the frame 508 preventing the edges of the frame from contacting the sternum.

The frame 508 is rigid and defines an alignment guide 512 and a depression into which a magnet 504 is mounted. The magnet 504 is secured in the frame 508 by washer 518.

The alignment guide 512 on the CPR pad 204-1 interacts with an alignment channel 510 in a flange 516, which is attached to the inner sleeve 234 of the ram 220. The action of placing the CPR pad 204-1 on the flange 516 causes cooperating angles located on the CPR pad and flange 522, 524, respectively to interact forcing the CPR pad to self-center on the flange, which causes the alignment guide to locate in the alignment channel. In this illustrative example, the flange 516 is made of ferrous metal so it interacts with the magnet 504 to create a magnetic attachment.

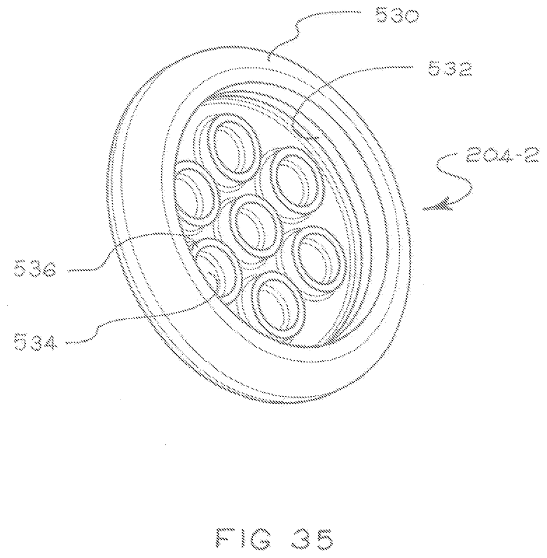

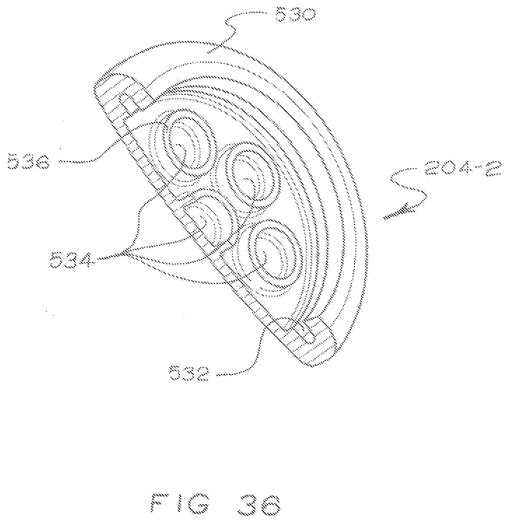

A second embodiment of CPR pad 204 is shown in FIGS. 35 and 36, generally referred to by reference number 204-2. The CPR pad 204-2 is made from a generally firm material that can be stretched.

The CPR pad 204-2 includes a body 530 that defines a retaining recess 532. It further includes multiple air pockets 534, each air pocket being of a cup shape and having a sealing surface 536.

In use, the CPR pad 204-2 is stretched over a flange (not shown) connected to the inner sleeve 234 of the ram 220. When placed on the flange, the sealing surfaces interact with a surface on the flange such that an air pocket is defined. When the CPR-pad 204-2 is compressed against the sternum, air will slowly escape from the air pocket; thereby, giving some degree of conformity of the CPR pad to the sternum. It should be appreciated that when the inner sleeve 234 of the ram 220 is retracting, the air pockets will refill with air as the CPR pad 204-2 returns to its normal configuration.

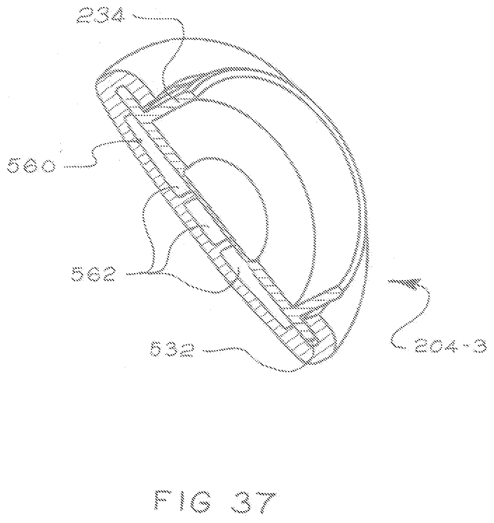

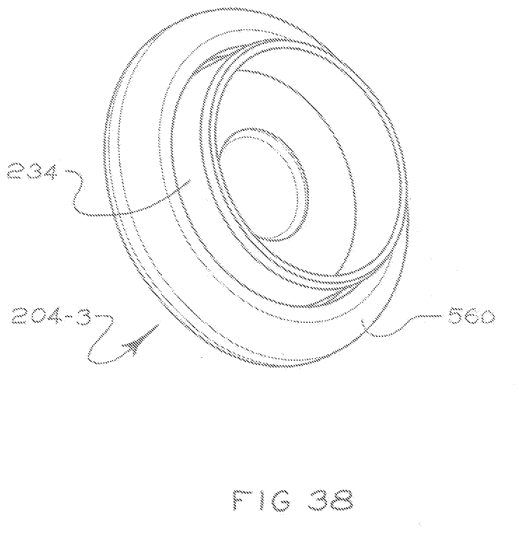

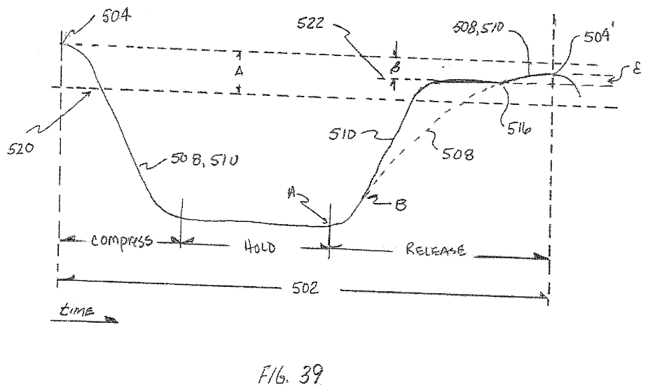

A third embodiment of CPR pad 204 is shown in FIGS. 37 and 38, generally referred to by reference number 204-3. The CPR pad 204-3 is similar to second embodiment of the CPR pad 204-2. Except in this embodiment, the pad 560 defines voids 562.

While the invention has been described above by reference to various embodiments, it will be understood that many changes and modification can be made without departing from the scope of the invention. In addition, as described above, the control system 350 contains a hardware processor with suitable components, such as memory, to retain and execute instructions to carry out the above functions. The programming needed to accomplish the above functions is well known in the art, and the programming can be written based on the above provided functional capabilities. It is therefore intended that the foregoing detailed description be understood as an illustration of the presently preferred embodiments of the invention, and not as a definition of the invention. It is only the following claims, including equivalents, which are intended to define the scope of this invention.

What is claimed is:

1. An apparatus for providing mechanical CPR to a victim comprising:
a mechanical CPR device having a compression module comprising a ram having a contact surface, the ram controlled by a control system capable of delivering CPR to a victim during a CPR session;
wherein, the control system comprises a hardware processor, a memory, and instructions stored in the memory and executable by the hardware processor, the instructions capable of performing the following steps:
establishing, by the control system, an initial therapeutic position for the contact surface of the ram relative to an initial position of the victim's chest,
controlling, by the control system, the ram to provide a CPR stroke thereby compressing the chest of the victim, and
establishing, by the control system, a beginning therapeutic position, where the beginning therapeutic position is based on a decompressed position of the chest of the victim at a beginning of a second CPR stroke.

2. The apparatus of claim 1, wherein the control system determines a contact level based on the initial therapeutic position, and then adjusts the contact level during the CPR session based on one or more beginning therapeutic positions.

3. The apparatus of claim 2, wherein the control system determines a therapeutic range based on the initial therapeutic position.

4. The apparatus of claim 3, wherein a user alert is enabled in the event the contact level is not within the therapeutic range.

5. The apparatus of claim 1, wherein a contact level is defined based on the initial therapeutic position, and the contact level is fixed during a CPR session.

6. The apparatus of claim 5, wherein the control system determines a therapeutic range based on the initial therapeutic position.

7. The apparatus of claim 6, wherein a user alert is enabled in the event the contact level is not within the therapeutic range.

8. A method for providing mechanical CPR to a victim comprising the steps of:
providing a mechanical CPR device having a control system, the control system comprising a hardware processor, a memory, and instructions stored in the memory and executable by the hardware processor, capable of performing the following steps:
establishing, by the control system, an initial therapeutic position for the contact surface of the ram relative to an initial position of the victim's chest,
controlling, by the control system, the ram to provide a CPR stroke thereby compressing the chest of the victim, and
establishing, by the control system, a beginning therapeutic position, where the beginning therapeutic position is based on a decompressed position of the chest of the victim at a beginning of a second CPR stroke.

9. The method of claim 8, including the step of determining a contact point based on the initial therapeutic position to be used throughout the CPR session.

10. The method of claim 8, including the step of adjusting the contact point based on the beginning therapeutic position.
